(19) United States
(12) Patent Application Publication
(10) Pub. No.: US 2008/0195570 A1
(43) Pub. Date: Aug. 14, 2008

(54) System and Method for Collecting Evidence Pertaining to Relationships Between Biomolecules and Diseases

(75) Inventors: Yasser H. Alsafadi, Yorktown Heights, NY (US); James David Schaffer, Wappingers Falls, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/910,056

(22) PCT Filed: Mar. 27, 2006
(86) PCT No.: PCT/IB06/50922

§ 371 Date: Sep. 28, 2007

Related U.S. Application Data
(60) Provisional application No. 60/666,922, filed on Mar. 31, 2005.

(51) Int. Cl. G06N 5/02

(52) U.S. Cl. 706/53

(57) ABSTRACT

A system and method for collecting evidence pertaining to relationships between biomolecules and a disease, or other clinical condition, wherein biomolecules associated with the disease or condition identified, and ontologies relating to the biomolecules, disease or condition, and a predicate relationship therebetween are generated (or input to a processing system). Triplets, subject/predicate/object, for example, biomolecule/relationship/disease, are constructed by processing the ontologies. The triplets are used to search a body of relevant evidence to extract pertinent data from the body of relevant data based on the triplets. The system and method of the invention is used to provide researchers in the field of molecular diagnostics with biological evidence for or against statistical predictions.

### BACKGROUND OF THE INVENTION

1. Field of the Invention

The present invention generally relates to the field of bioinformatics and, more particularly to, a system and method for collecting evidence pertaining to relationships between biomolecules and diseases, or other clinical condition.

2. Description of the Related Art

The development of profiles of molecular alterations in human tumors presents a major challenge to the biomedical research community. These “molecular signatures” are intended to redefine tumor classification, moving from morphology-based classification schemes to molecular-based classification schemes. As a result, researchers have enriched the biomedical literature with large volumes of information about biomolecules and their relationship to diseases. A biomolecule is a molecule that naturally occurs in living organisms.

It is known to use statistical methods (e.g., neural networks) to identify potential sets of biomolecules that may be linked to certain diseases. In order to validate (or check the reasonableness of) the results of statistical pattern discovery experiments, a literature search is typically performed to determine what other researchers know about potential relationships between a biomolecule and a particular disease.

PCT Patent Publication WO 02/099725 discloses systems, methods and computer programs for processing biological databases and/or chemical databases. According to this publication, biological/chemical databases are integrated by obtaining an entity-relationship model for each of the biological/chemical databases, and related entities in the entity relationship models of at least two of the bio-logical/chemical databases are identified. At least two of the related entities that are identified are linked so as to create an entity-relationship model that integrates the plurality of the biological databases. The entity-relationship model that integrates the biological/chemical databases provides an ontology network that integrates the diverse ontologies that are represented by the independent biological/chemical databases. By navigating the entity-relationship model in response to queries, relationships between biomolecules and diseases or other clinical conditions may be obtained.

An ontology is a formal and declarative representation which includes the vocabulary (or names) for referring to terms in a subject area, and the logical statements that describe what the terms are, how they relate to each other, and how they can or cannot relate to each other. An ontology provides a vocabulary for representing and communicating knowledge about some subject and a set of relationships that hold among the terms in the vocabulary, e.g., a hierarchy, a network or some other relationship.

One problem associated with performing the searches disclosed in WO 02/099725 is that the searches are limited to databases that have obtainable entity-relationship models. Another drawback of the searches is that the addition of new databases to the “discovery space” requires the application of an algorithm to integrate the old and new databases. As a result, an expert is required to implement the algorithm to integrate the databases.

A manual search of a database, such as a database of medical literature, is time consuming and tedious. One solution to the tedium of performing manual literature searches is to use Infobots to perform the search. An Infobot connects to an Internet Relay Chat (IRC) server, potentially joins some channels and accumulates factoids, i.e., facts that have no existence before appearing in a magazine or newspaper, or a small piece of true but often valueless or insignificant information. On the Internet, Infobots are programs (i.e., spiders or crawlers) used for searching. They access web sites, retrieve documents and follow all the hyperlinks in them, and generate catalogs that are accessed by search engines. With respect to performing searches, the search/query criteria that are used by the Infobot must be clearly defined. Otherwise, the Infobot will retrieve a large number of irrelevant references, while bypassing many relevant ones.

### SUMMARY OF THE INVENTION

The present invention is a system and method for collecting evidence pertaining to relationships between biomolecules and a disease, or other clinical condition. The existence of biomolecules indicates a person's predisposition to a particular disease. An analysis is performed to identify the particular set of biomolecules that is used to determine whether a patient has the particular disease.

Databases of publicly available ontologies are accessed to generate an individual ontology for a subject. The publicly available ontologies are queried to generate the biomolecule ontology, which contains a network of biomolecule expressions. An ontology is a formal and declarative representation which includes the vocabulary (or names) for referring to terms in a subject area, and the logical statements that describe what the terms are, how they relate to each other, and how they can or cannot relate to each other. An ontology provides a vocabulary for representing and communicating knowledge about some subject and a set of relationships that hold among the terms in the vocabulary, e.g., a hierarchy, a network or some other relationship.

An ontology of a disease, disorder, syndrome, abnormality or other medical problem is generated by querying the publicly available ontologies. The ontology of a disease may include a hierarchy of the manifestations and synonyms of these manifestations.

The ontology for the predicate (i.e. the relationship) between the biomolecules and the diseases is generated. The ontology for the predicate provides a description of the concepts and relationships that can exist between an “object” and a community of “objects.” In this case, the “object” is the specific disease that is being studied. The predicate addresses the reason for collecting the evidence, i.e. the biomolecules associated with a disease. The predicate can encode causal relationships, or encode linking relationships that document an association between the biomolecule and a specific disease. An encoded relationship is advantageously useful for collecting evidence where causal relationships have been asserted, whereas encoded linking relationships are advantageously useful when the relationships are not fully understood.

Upon the development of three ontologies (i.e. a triplet), the triplet is used to perform a natural language parse on a medical literature database to locate articles that are relevant to the subject at hand, i.e., the biomolecule-disease relationship. Once the relevant medical articles are located and assembled, the result is provided to a researcher who utilizes known graphical user interface (GUI) tools to aid in the interpretation of the generated result.

The present invention eliminates the need to manually determine the biological relevance of medical articles to specific disease. As a result, researchers can devote more time to discovering new relationships between specific diseases and biomolecules. In addition, researchers are shielded from pursuing leads that provide inconclusive results. As a result, overall efficiency is increased.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The foregoing and other advantages and features of the invention will become more apparent from the detailed description of the preferred embodiments of the invention given below with reference to the accompanying drawings in which:

FIG. 1 is an exemplary diagram illustrating the relationship between a biomolecule and a disease that is derived in accordance with the method of the invention;

FIG. 2 is a schematic block diagram illustrating a system for collecting evidence pertaining to relationships between biomolecules and a disease in accordance with the invention;

FIG. 3 is a schematic block diagram illustrating the different views of a resultant search in accordance with the invention; and

FIG. 4 is an illustration of triplets in accordance with the method of the invention;

FIG. 5 is a flow chart illustrating the steps for refining the results obtained by the method of FIG. 4; and

FIG. 6 is a schematic block diagram of a general-purpose computer for implementing the method of the present invention.

### DETAILED DESCRIPTION OF THE EXEMPLARY EMBODIMENTS

The present invention is a system and method for collecting evidence pertaining to relationships between biomolecules and a disease, or other clinical condition. In accordance with the invention, the biomolecules associated with a disease are identified using a statistical analysis, such as the neural network described in U.S. Pat. No. 6,601,053, which is incorporated herein by reference. Researchers and medical personnel in the field of molecular diagnostics are provided with biological evidence for validating statistical predictions, such as, for example, pattern recognition functions. A statistical approach is used to predict whether the occurrence of a particular set of biomolecules is indicative of a particular disease. Using this prediction, the relationship between a biomolecule and the disease is derived and used to perform a database search to locate articles that are relevant to the particular biomolecule-disease relationship.

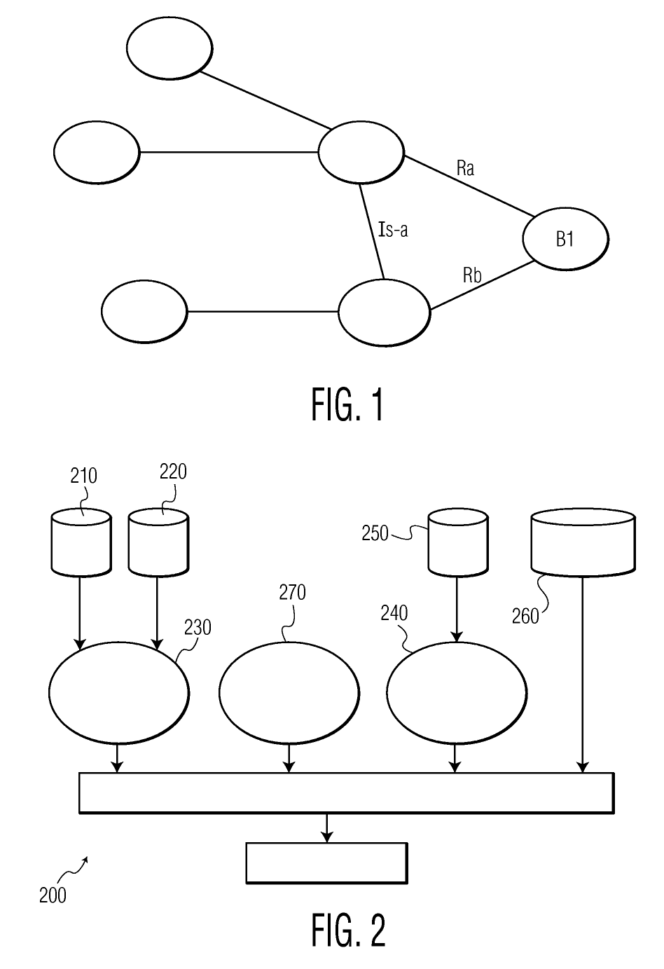

FIG. 1 is an exemplary diagram of the relationship between a biomolecule and the disease cancer that is derived in accordance with the present invention. Biomolecule BRCA1 is shown. This biomolecule indicates a person's predisposition to develop cancer, where ovarian cancer is also associated with biomolecule B1. CA125 is the specific biomarker for ovarian cancer. The particular set of biomolecules that is used to identify whether a patient has the particular disease is identified.

FIG. 2. is a schematic block diagram illustrating a system 200 for collecting evidence pertaining to relationships between biomolecules and a disease in accordance with the invention. Databases of publicly available ontologies 210 or 220 are accessed to generate an individual ontology for a subject, i.e., a biomolecule ontology 230. An ontology is a formal and declarative representation which includes the vocabulary (or names) for referring to terms in a subject area, and the logical statements that describe what the terms are, how they relate to each other, and how they can or cannot relate to each other. An ontology provides a vocabulary for representing and communicating knowledge about some subject and a set of relationships that hold among the terms in the vocabulary, e.g., a hierarchy, a network or some other relationship.

Biomolecule ontology 230 contains a network of biomolecule expressions, such as expressions at RNA level, expressions following protein translations, mutations, DNA deletions, DNA amplifications, epigenetic changes of DNA, and/or post-translational modifications. A publicly available ontology is queried to generate biomolecule ontology 230. The publicly available ontologies are the Gene Ontology (GO) or the structural proteomics set forth in Bertone P. et al. “SPINE: An Integrated Tracking Database and Data Mining Approach for Identifying Feasible Targets in High-Throughput Structural Proteomics.” Nucleic Acids Res. 2001, 29: 2884-2898. Other ontologies may be queried to obtain an ontology for the biomolecule.

An ontology of a disease, disorder, syndrome, or abnormality 240 is generated by querying ontologies 250, such as those found in the Unified Medical Language System (UMLS). The ontology of the disease contains a hierarchy of the problem's manifestations and the synonyms to these manifestations of the disease, disorder, syndrome, or abnormality.

The ontology for the predicate 270 (i.e. the relationship) between the biomolecules and the diseases is generated. The ontology for the predicate 270 provides a description of the concepts and relationships that can exist between an “object” and a community of “objects.” In this case, the object is the specific disease that is identified. The predicate 270 addresses the motivation for collecting the evidence, i.e. the biomolecules associated with a disease. The predicate can encode causal relationships, or encode linking relationships that document an association between the biomolecule and a specific disease. An encoded relationship is advantageously useful for collecting evidence where causal relationships have been asserted, whereas encoded linking relationships are advantageously useful when the relationships are not fully understood.

Upon the development of three ontologies (i.e., a triplet comprised of a subject, the predicate and an object), the triplet is used to perform a natural language parse on medical literature database 260 to locate articles that are relevant to the subject at hand, i.e., the biomolecule. Once the relevant medical articles are located and assembled, the result is provided to a researcher who utilizes known visualization tools to aid in the interpretation of the generated result, such visual tools include a graphical user interface running on a computer.

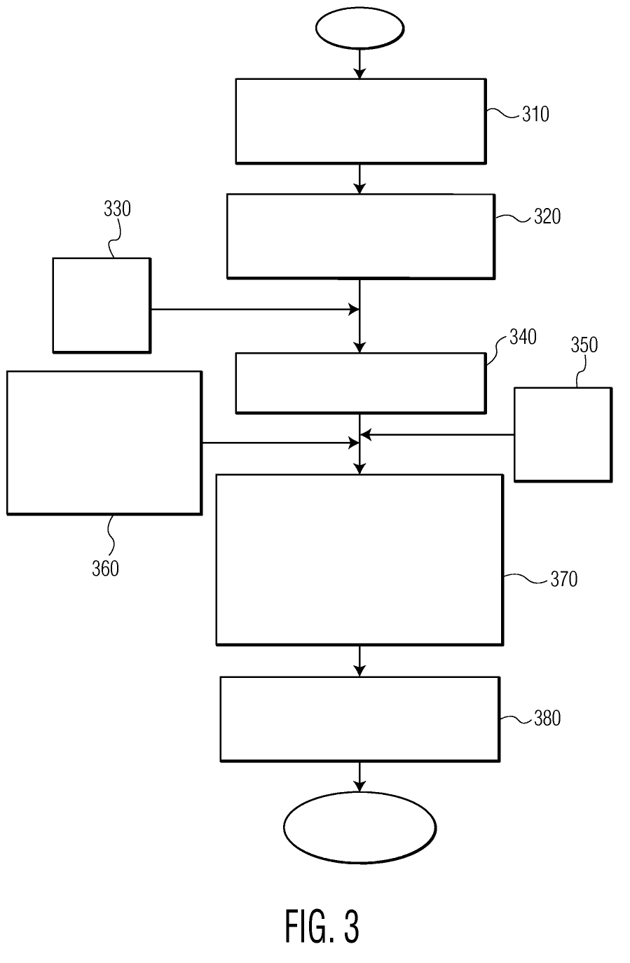

FIG. 3 is a flow chart illustrating the steps of the method for collecting evidence pertaining to relationships between biomolecules (at least one subject) and diseases (object) in accordance with the present invention. First, the biomolecules associated with a disease are identified, selected or otherwise made available for processing, for example, identified by a statistical method, as indicated in step 310.

Next, the ontology for the predicate (i.e. relationship) between the biomolecules and the diseases is generated, as indicated in step 320. The ontology for the predicate provides a description of the concepts and relationships that can exist between an “object” and a community of “objects.” In this case, the object is the specific disease that is being researched. The predicate addresses the motivation for collecting the evidence, i.e. the biomolecules associated with a disease. The predicate can encode causal relationships, or encode linking relationships that document an association between the biomolecule and a specific disease. An encoded relationship is advantageously useful for collecting evidence where causal relationships have been asserted, whereas encoded linking relationships are advantageously useful when the relationships are not fully understood.

Next, the ontology for each biomolecule is generated, as indicated in step 320. Ontologies of combinations of biomolecules are also preferably generated. The ontology for the biomolecule contains a network of the biomolecule expressions such as expressions at RNA level, expressions following protein translations, mutations, DNA deletions, DNA amplifications, epigenetic changes of DNA, or post-translational modifications. Here, a publicly available ontology is queried to generate the ontology for the subject biomolecule. The publicly available ontology is preferably the Gene Ontology (GO), or the structural proteomics set forth in Bertone P. et al. “SPINE: An Integrated Tracking Database and Data Mining Approach for Identifying Feasible Targets in High-Throughput Structural Proteomics.” Nucleic Acids Res. 2001, 29: 2884-2898. Other ontologies may also or instead be queried to obtain an ontology for the biomolecule.

While not necessary, at times it is preferred to refine the ontology of the biomolecule, as indicated in step 330. This step permits researchers to view the generated ontology and refine the search scope for the biomolecule. A visualization tool, or a user interface is used to aid in the performance of the refinement in a manner that is known.

Next, the ontology of the object is generated, as indicated in step 340. The object is a disease, disorder, syndrome, abnormality or other medical problem. The ontology of the object contains a hierarchy of the problem's manifestations and the synonyms of these manifestations of the object. The ontology is preferably constructed by performing queries in ontologies such as those found in the Unified Medical Language System (UMLS).

While not necessary, is at times preferred to manually refine the ontology of the object, as indicated in step 350. Manually refining the ontology of the object permits researchers to view the generated ontology and refine the search scope for the object. Known visualization tools, or a known user interface is preferably used to aid in the refinement of the object.

A triplet for each biomolecule (or subject ontology element)) is constructed, as indicated in processing step 370. In accordance a preferred embodiment, the triplet comprises the subject, predicate, and object. First, an ontology of a predicate or relationship between the object (disease) and subject (biomolecule or derivative) must be available, whether imported, generated or derived for use with the object and subject ontologies. This availability is indicated by step 360.

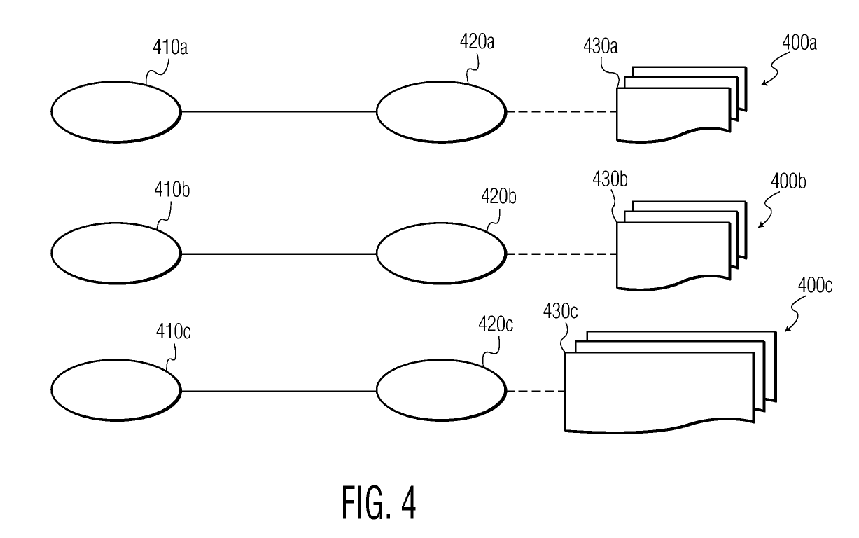

FIG. 4 is an illustration of three different triplets that can be formed in accordance with present invention. Resource description framework (RDF) view is used to form triplet 400a. This triplet comprises a subject 410a, a predicate and an object 420a that is linked to references in a medical data based 400a. When the triplet is generated in the abstract view, the triplet 400 will be comprised of a biomolecule 410b, the relationship and the disease 420b that is linked to Medline references 430b. When the triplet 400 is generated in the real view, it is comprised of BRCA2 410c, a relationship, and breast cancer 420c, which is linked to a specific URL 430c. Three triplets subject/biomolecule/BRCA2 (400a), predicate/relationship/cause (400b), and object/disease/breast cancer (400c) are equivalent representations of the same triplet concept. In the preferred embodiment, the resource description framework (RDF) is used to form the triplet.

Next, the triplet is used to perform a natural language parse (search of the available pool of relevant data), e.g., the relevant medical literature, to extract the data pertinent triplets, e.g., articles relevant to the subject at hand. By relevant, it should be understood to mean any data parsed from the database(s) under search based relationship between the subject and object, and any variation thereon, as defined by the set of triplets. For example, any articles which may be relevant to the relationship between the biomolecule (and derivatives) and the disease, as indicated in step 380.

It should be noted that the pool of available evidence, e.g., medical literature, is identified prior to parsing the triplet of the biomolecule. Step 390 is repeated until each individual biomolecule or derivatives (i.e., each of the elements comprising the generated subject ontology) is processed as the triplet with the predicate and elements of the object ontology. Once each biomolecule is processed, the result of the processing is provided to a researcher, as indicated in step 360. The results are generated as biomolecule-relationship-disease-references, as shown in FIG. 1. At this juncture, researchers can use known visualization tools to aid in the interpretation of the results of the generated result, e.g., a known graphical user interfaces, such as computer running a software program, to aid in interpreting the results of the generated result.

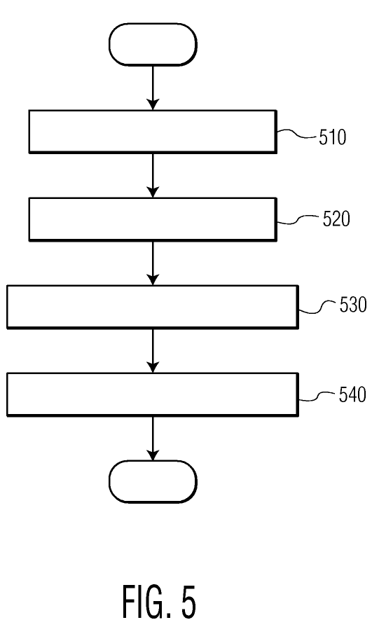

FIG. 5 is a flow chart illustrating the steps of an exemplary method for refining the results obtained by the method of FIG. 3. Enhancement of the results is achieved by obtaining the search result that was previously generated, as indicated in step 510. Next, the references containing the search result are grouped, as indicated in step 520. Here, the references are grouped according to domain, specialty, kind of publication, strength of evidence, or the like. In an embodiment of the invention, a document clustering tool is used to group the references.

The results of the search are presented to the researcher and the specific references that are accessed/read/studied by the researcher is noted, as indicated in step 530.

The triplets generated in step 370 are adjusted and stored, as indicated in step 540. As a result, subsequent searches that are performed by a researcher are influenced by the enhancement. In an alternative embodiment, the triplets are used to add “weights” to the different elements in the ontologies.

In an additional embodiment, a learning function is implemented in the presentation step of 530 and the adjusting step of 540 further refine the search results. For example, when a large amount of target literature is analyzed, the researcher is permitted to explicitly denote areas of further interest, or subject areas that the researcher thinks may have been missed during the search. This denotation is accomplished by annotating or highlighting (e.g., double clicking) the relevant subject areas in the manner associated with browsing or editing a document.

It is possible to use the enhanced query in a number of multiple ways. In the preferred embodiment, the enhanced query is used in at least two ways. For example, if the researcher suspects that the original query may have missed significant existing literature (i.e. the query is widened), then the enhanced query may be re-run immediately. On the other hand, if the coverage of the search was adequate, but the refinements would make the search more precise (i.e. the query is narrowed), there would be little value in re-running the search immediately since the researcher would already possess the most relevant literature. However, if the results of the search are less than expected and the field of research is known to be very active suggesting that new information may be published or made available in the near future, then the enhanced search may be provided to an “Infobot” for future use. As a result, newer and possibly more relevant medical articles will be discovered as they are published.

The present invention may be implemented using a conventional general-purpose digital computer or appropriately programmed microprocessor. The present invention includes a computer program product which is a storage medium including instructions which can be used to program a computer to perform present invention. The storage medium can include, but is not limited to, any type of disk including floppy disks, optical discs, CD-ROMs, and magneto-optical disks, DVDs, ROMs, RAMs, EPROMs, EEPROMs, magnetic or optical cards, or any type of media, including hard drives, suitable for storing electronic instructions.

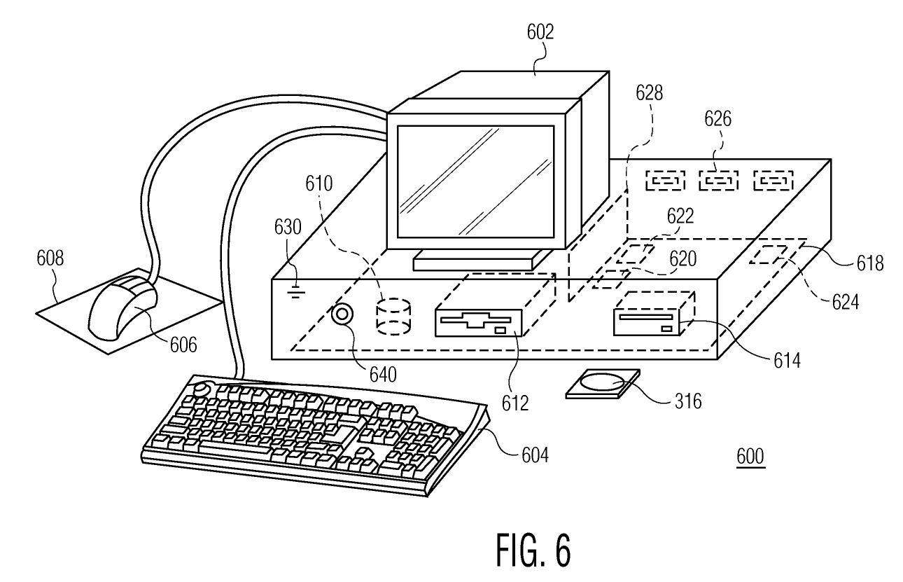

FIG. 6 is a schematic block diagram of a general-purpose computer 600 for implementing the present invention. The computer 600 includes a display device 602, such as a touch screen monitor with a touch-screen interface, a keyboard 604, a pointing device 606, a mouse pad or digitizing pad 608, a hard disk 610, or other fixed, high density media drives, connected using an appropriate device bus, such as a SCSI bus, an Enhanced IDE bus, a PCI bus, etc., a floppy drive 612, a tape or CD ROM drive 614 with tape or CD media 616, or other removable media devices, such as magneto-optical media, etc., and a mother board 618. The motherboard 618 includes, for example, a processor 620, a RAM 622, and a ROM 624, I/O ports 626 which are used to couple to an image acquisition device (not shown), and optional specialized hardware 628 for performing specialized hardware/software functions, such as sound processing, image processing, signal processing, neural network processing, etc., a microphone 630, and a speaker or speakers 640.

On any one of the above-described storage media (computer readable media), is stored appropriate programming for controlling both the hardware of the computer 600 and for enabling the computer 600 to interact with a human user. Such programming may include, but is not limited to, software for implementation of device drivers, operating systems, and user applications. Such computer readable media further includes programming or software instructions to direct the general-purpose computer 600 to perform tasks in accordance with the present invention.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results be within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method for collecting pertinent evidence to support an investigation and verification of possible relationships between objects and subjects from a body of available evidence, comprising the steps of:
selecting at least one subject that includes a suspected association with an object;
generating a hierarchical structure of subjective elements which capture different representations or characterizations of the at least one subject;
generating a hierarchical structure of objective elements, which capture different representations, or characterizations of an object;
processing the subjective elements to generate predicate relationships for each objective element utilizing a predicate hierarchy to construct a set of object/subject/predicate triplets;
searching the body of evidence to extract the pertinent evidence utilizing the set of triplets; and
outputting the pertinent evidence.

2. The method of claim 1, wherein the step of outputting includes displaying the pertinent evidence for user viewing.

3. The method of claim 1, wherein the step of outputting includes storing the pertinent evidence in a structured data format.

4. The method of claim 1, wherein the step of selecting the at least one subject includes the use of a statistical method.

5. The method of claim 4, wherein the statistical method includes a mass spectrographic analysis.

6. The method of claim 1, further comprising a step of identifying a body of target literature to define the body of available evidence.

7. The method of claim 1, wherein the step of generating the hierarchical structure of objective elements includes an adaptive refinement of said hierarchical structure of objective elements.

8. The method of claim 7, wherein the adaptive refinement includes manually refining said hierarchical structure of objective elements.

9. The method of claim 1, wherein the step of generating the hierarchical structure of subjective elements includes an adaptive refinement of said hierarchical structure of subjective elements.

10. The method of claim 9, wherein the adaptive refinement includes manually refining said hierarchical structure of subjective elements.

11. The method of claim 1, wherein the step of processing includes generating the predicate hierarchy.

12. The method of claim 1, wherein the object is a disease, disorder, syndrome or abnormality being researched.

13. The method of claim 1, wherein each hierarchical structure comprises at least one of sets of descriptors, sets of descriptor synonyms and sets of descriptor derivatives, which sets combined define an ontological representation of the subjects, objects or predicate representations.

14. The method of claim 1, wherein said step of generating the hierarchical structure of objective elements comprises querying hierarchies of a unified medical language system.

15. The method of claim 1, wherein said processing step further comprises the step of generating combinations of hierarchical structures of subjective elements.

16. The method of claim 1, wherein the at least one subject is a biomolecule.

17. The method of claim 1, wherein the hierarchical structure of subjective elements includes a network of subject expressions.

18. The method of claim 17, wherein the subject expressions are at least one of expressions at RNA level, expressions subsequent to protein translations, mutations, DNA deletions, DNA amplifications, epigenetic changes of DNA and post-translational modifications.

19. The method of claim 17, wherein said step of searching the body of evidence includes querying a pool of publicly and/or privately available information.

20. The method of claim 1, wherein the step of generating a hierarchical structure of subjective elements includes searching a Gene Ontology (GO) and/or a structural proteomics set.

21. The method of claim 1, wherein the triplet is constructed using a resource description framework.

22. The method of claim 1, wherein the content of the pertinent evidence is structured in accordance with one of: domain and specialty.

23. The method of claim 22, wherein the pertinent evidence is structured in accordance with a document-clustering tool.

24. The method of claim 1, wherein the step of selecting includes utilizing a neural network, or a combination of a genetic algorithm with a learning classifier system (e.g. neural network, naïve Bayesian classifier, k-nearest neighbor classifier, self-organizing map, support vector machine or the like).

25. The method of claim 1, wherein the triplet is constructed using RDF notation.

26. The method of claim 1, wherein the step of searching implements a natural language parsing approach, utilizing the triplet, to search the pool of available biomedical literature.

27. The method of claim 7, wherein the adaptive refinement includes the steps of:
selectively grouping the extracted pertinent evidence;
presenting the results of the selective grouping in order that a user may access, read and/or study, wherein an identifier is generated and attributed to a particular group upon selection of said particular grouping by the user for access, reading or studying; and
adjusting said triplets based on one or more said identifier.

28. The method of claim 27, wherein said step of adjusting includes further searching the body of evidence utilizing said adjusted triplets.

29. The method of claim 2, wherein if said step of outputting the pertinent evidence finds no pertinent evidence, further analysis implemented to deduce whether there is a dearth of pertinent evidence relating to said triplets, or that said triplets are inaccurate for the intended collection.

30. A computer readable medium comprising a set of instructions that may be implemented on a general purpose computer for carrying out the method of claim 1.

31. A system for collecting pertinent evidence from a pool of evidence, said evidence qualified as pertinent evidence in accordance with predicate relationships linking subjects and objects, comprising:
a selector for communicating at least subject definition into the system;
a subject database comprising subject hierarchies comprising subjective elements, the subjective elements representing varying and derivative characteristics of said at least one subject;
an object database comprising object hierarchies comprising objective elements, the objective elements representing varying, derivative and/or synonymous representations of the object;
a relationship database which includes operability for detecting any number of causal or linking relationships between the subjective and objective elements, and encoding a plurality of subject/predicate/object triplets based on said detecting;
a processor which implements a natural language parsing approach on the pool of evidence, utilizing said triplets, in order to extract said pertinent evidence;

32. The system of claim 31, wherein the at least one subject is a biomolecule, and the object is a disease, disorder, syndrome or abnormality.

33. The system of claim 31, wherein the subject, object and relationship databases comprise subject, object and relationship ontologies.

34. The system of claim 31, wherein the selector, the subject database, the object database, the relationship database and processor comprise a distributed network.

35. The system of claim 31, wherein the selector identifies the at least one subject utilizing a statistical process.

36. The system of claim 31, wherein the processor includes an ability to present each piece of relevant data as a biomolecule/relationship/disease/reference format.

37. The system of claim 31, further including a document clustering tool, wherein the pool of available evidence is documentary, and the clustering tool groups the pertinent documents according to at least one of domain, specialty, publication type, strength of evidence, and like grouping qualifications.

38. The system of claim 31, wherein the processor identifies and assigns attributes to accessed documents, refines the encoding performed by the relationship database in accordance the attributes to generate refined triplets, and causes a re-parsing of the evidence using the refined triplets.
